(19) United States
(12) Patent Application Publication
(10) Pub. No.: US 2013/0299740 A1
(43) Pub. Date: Nov. 14, 2013

(54) BISTABLE BLUE PHASE LIQUID CRYSTAL

(71) Applicant: Zhigang Zheng, Xuhui District (CN)

(72) Inventor: Zhigang Zheng, Xuhui District (CN)

(73) Assignee: EAST CHINA UNIVERSITY OF SCIENCE AND TECHNOLOGY, Shanghai (CN)

(21) Appl. No.: 13/825,907

(22) PCT Filed: Apr. 27, 2012
(86) PCT No.: PCT/CN12/74809

§ 371 Date: Mar. 25, 2013

(51) Int. Cl. C09K 19/02

(52) U.S. Cl. CPC C09K 19/0275
USPC 252/299.01; 428/1.6

(57) ABSTRACT

Composite materials, methods of making the composite materials, and optical devices including the composite materials are described herein. The composite materials include a chiral nematic liquid crystal and a crosslinked polymer. The composite materials form bistable liquid crystals and have a liquid crystal blue phase with a stability range greater than 60° C.

### BACKGROUND

Bistable liquid crystals have attracted attention for potential applications in displays and information storage. The bistable phenomenon, wherein a material has two stable liquid crystal phases, has been observed in ferroelectric liquid crystals, dual-frequency liquid crystals, and polymer stabilized cholesteric textures (PSCT). Substrate anchoring has also been used to induce the bistable state in some materials. Bistable devices including displays, light shutters, intensity modulators, lenses, and photonic crystals have been fabricated.

### SUMMARY

This disclosure is not limited to the particular systems, devices and methods described, as these may vary. The terminology used in the description is for the purpose of describing the particular versions or embodiments only, and is not intended to limit the scope. While various compositions and methods are described in terms of “comprising” various components or steps (interpreted as meaning “including, but not limited to”), the compositions and methods can also “consist essentially of” or “consist of” the various components and steps, and such terminology should be interpreted as defining essentially closed-member groups.

In an embodiment, a method of preparing a composite material comprises providing a thin film of a mixture including a chiral nematic liquid crystal and at least one polymerizable monomer, and polymerizing the at least one polymerizable monomer. In some embodiments, the at least one polymerizable monomer may comprise at least about 75% of a crosslinking monomer.

In an embodiment, a composite material comprises a chiral nematic liquid crystal and a crosslinked polymer that may be the reaction product of at least one polymerizable monomer comprising at least about 75% of a crosslinking monomer. In some embodiments, the composite material may be a bistable liquid crystal having a liquid crystal blue phase and chiral nematic phase.

In an embodiment, an optical device comprises a composite material with a liquid crystal blue phase having a stable temperature range of at least about 60° C. The composite material includes a chiral nematic liquid crystal and at least one crosslinked polymer that is the reaction product of at least one polymerizable monomer comprising at least about 75% of a crosslinking monomer.

### DESCRIPTION OF FIGURES

FIG. 1 is a scheme demonstrating the phase transition behavior of a composite material in accordance with an embodiment.

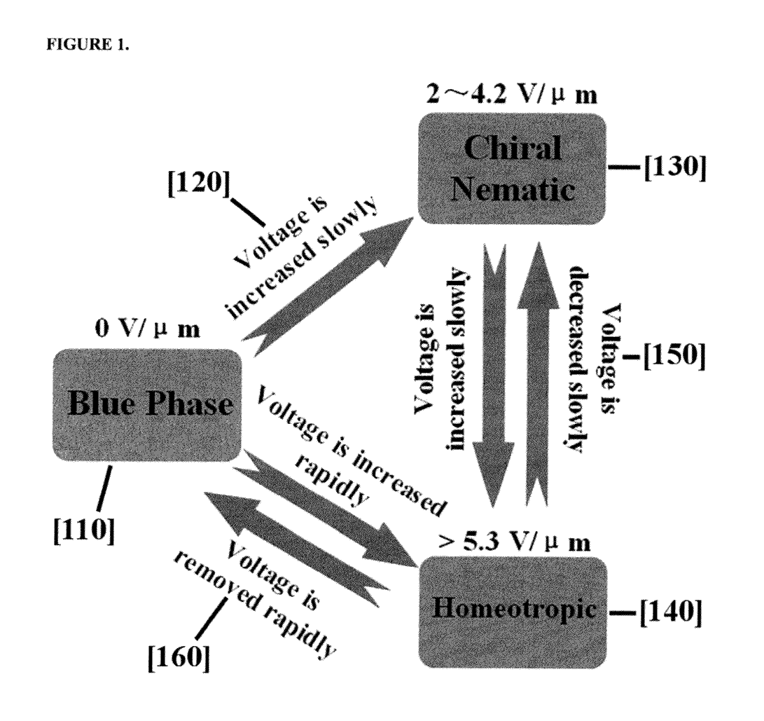

FIG. 2 is a plot of transmission versus applied voltage in accordance with an embodiment.

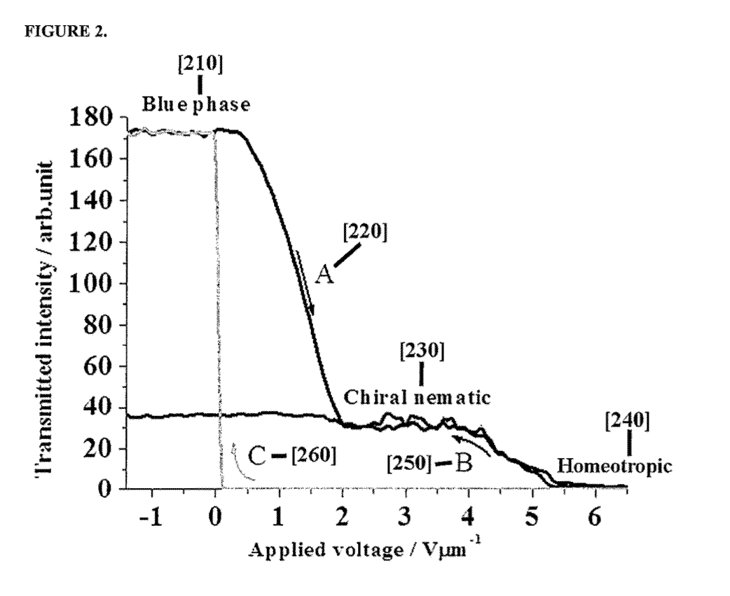

### DETAILED DESCRIPTION

Herein are described composite materials, methods of making composite materials, and optical devices comprising the composite materials. The composite materials may be bistable liquid crystals and may have a liquid crystal blue phase with greater than a 60° C. stability range.

In an embodiment, a composite material may comprise a chiral nematic liquid crystal and a crosslinked polymer that is the reaction product of at least one polymerizable monomer. In some embodiments, the composite material may have a liquid crystal blue phase. In some embodiments, the composite material may be a bistable liquid crystal. In some embodiments, the composite material may also have a chiral nematic phase.

In embodiments, a chiral nematic liquid crystal may comprise about 60 weight percent to about 90 weight percent nematic liquid crystals and about 10 weight percent to about 40 weight percent chiral dopant. In some embodiments, the chiral nematic liquid crystal may comprise about 70 weight percent to about 80 weight percent nematic liquid crystals and about 20 weight percent to about 30 weight percent chiral dopant. In some embodiments, the chiral nematic liquid crystal may comprise about 75 weight percent nematic crystals and about 25 weight percent chiral dopant. Specific examples of chiral nematic liquid crystal contents include about 60 weight percent, about 70 weight percent, about 80 weight percent, about 90 weight percent, and values or ranges between any two of these values, inclusive of endpoints. Specific examples of chiral dopant contents include about 10 weight percent, about 20 weight percent, about 30 weight percent, about 40 weight percent, and values or ranges between any two of these values, inclusive of endpoints.

In some embodiments, the crosslinked polymer may be present in the composite material at about 2 weight percent to about 20 weight percent, at about 5 weight percent to about 10 weight percent, or at about 7 weight percent. Exemplary amounts of the crosslinked polymer include, but are not limited to, about 2%, about 4%, about 6%, about 8%, about 10%, about 12%, about 14%, about 16%, about 18%, about 20%, or any amount or range of amounts between those listed, inclusive of endpoints.

In some embodiments, a polymerizable monomer may comprise at least about 71%, at least about 75%, at least about 80%, at least about 85%, at least about 90%, at least about: 95%, or about 100% of a crosslinking monomer. In some embodiments, the at least one polymerizable monomer may comprise about 100% of the crosslinking monomer. The at least one polymerizable monomer may comprise exemplary amounts of the crosslinking monomer including, but not limited to, about 71%, about 73%, about 75%, about 77%, about 79%, about 81%, about 83%, about 85%, about 87%, about 89%, about 90%, about 92%, about 94%, about 96%, about 98%, about 100%, or any amount or range of amounts between those listed, inclusive of endpoints.

In some embodiments, the crosslinked polymer may be any crosslinked polymer known in the art wherein the crosslinked polymer forms a crosslinked network that stabilizes the liquid crystal blue phase of the composite material. In some embodiments, the crosslinked polymer may be a polyacrylate polymer and the crosslinking monomer may comprise a diacrylate monomer. In some embodiments, the crosslinked polymer may be a polyacrylate polymer and the crosslinking monomer may comprise 1,4-bis-[4-(3-acryloyloxyypropyloxy)benzoyloxy]-2-methylbenzene.

In some embodiments, the liquid crystal blue phase of the composite material may have a stable temperature range of about 20° C. to about 100° C., about 40° C. to about 80° C., or at least about 60° C. Exemplary stable temperature ranges include, but are not limited to, about 20° C., about 30° C., about 40° C., about 50° C., about 60° C., about 70° C., about 80° C., about 100° C., or any temperature or range of temperatures between those listed, inclusive of endpoints.

In some embodiments, the composite material may be adapted to have electrically driven phase transitions when the composite material is in an electric field that may be created by an applied voltage. For example, the composite material may be configured to form a stable liquid crystal blue phase 110 if the composite material is in an electric field with a strength that is below a threshold value. The composite material may be configured to transition 120 from a liquid crystal blue phase to a chiral nematic phase if the composite material is in an electric field with a strength that is increased above a threshold value, but remains below a saturation value. The composite material may have a stable chiral nematic phase 130 if the composite material is in an electric field with a strength that is above a threshold value and below a saturation value. The composite material may be configured to transition 140 from a chiral nematic phase to a homeotropic phase 150 if the composite material is in an electric field with a strength that is increased above a saturation value. The composite material may be configured to transition 140 from a homeotropic phase to a chiral nematic phase if the composite material is in an electric field with a strength that is below a saturation value, but above a threshold value.

In some embodiments, the composite material may be configured to transition 160 from a liquid crystal blue phase to a homeotropic phase if the composite material is in an electric field with a strength that is increased above a saturation value in a single step. In some embodiments, the composite material may be configured to transition 160 from a homeotropic phase to a liquid crystal blue phase if the composite material is in an electric field with a strength that is decreased from above a saturation value to a field strength below a threshold value in a single step.

In embodiments, the composite material may have a thickness of about 0.1 μm to about 100 μm, about 0.25 μm to about 30 μm, about 10 μm to about 20 μm, or about 15 μm. Exemplary thicknesses include, but are not limited to, about 0.25 μm, about 0.5 μm, about 0.75 μm, about 1 μm, about 1.5 μm, about 2 μm, about 4 μm, about 8 μm, about 10 μm, about 15 μm, about 20 μm, about 25 μm, about 30 μm, about 50 μm, or any thickness or range of thicknesses between those listed, inclusive of endpoints.

In some embodiments, the composite material may be positioned between two electrodes separated by a distance equal to at least the thickness of the composite material. In such embodiments, a voltage may be applied across the two electrodes, thereby creating an electric field. In some embodiments, the composite material may be configured to form a stable liquid crystal blue phase 210 if it is in an electric field created by applying a voltage of less than about 0.4 V per μm of thickness. The composite material may be configured to transition 220 from a liquid crystal blue phase to a chiral nematic phase if it is in an electric field created by applying a voltage that is increased to greater than about 0.4 V per μm of thickness, but less than about 4.2 V per μm of thickness. In an embodiment, the voltage may be increased in steps of about 0.1 V per μm of thickness to about 2 V per μm of thickness. The composite material may have a stable chiral nematic phase 230 if it is in an electric field created by applying a voltage of about 2 V per μm of thickness to about 4.2 V per μm of thickness. The composite material may be configured to transition from a chiral nematic phase to a homeotropic phase 240 if it is in an electric field created by applying a voltage that is increased to greater than about 5.3 V per μm of thickness. The composite material may be configured to transition 250 from a homeotropic phase to a chiral nematic phase if it is in an electric field created by applying a voltage that is decreased to less than about 5.3 V per μm of thickness, In art embodiment, the voltage may be decreased in steps of about 0.1 V per μm of thickness to about 2 V per μm of thickness.

In some embodiments, the composite material may be configured to transition from a liquid crystal blue phase to a homeotropic phase if it is in an electric field created by applying a voltage that is increased to at least about 5.3 V per μm of thickness. In such an embodiment, the voltage may be increased in steps greater than about 2 V per μm of thickness. The transition from a liquid crystal blue phase to a homeotropic phase may be completed in about 0.5 ms.

In some embodiments, the composite material may be configured to transition 260 from a homeotropic phase to a liquid crystal blue phase if it is in an electric field created by applying a voltage that may be decreased to less than about 0.4 V per μm of thickness. In such an embodiment, the voltage may be decreased in steps greater than about 2 V per μm of thickness. The transition from a homeotropic phase to a liquid crystal blue phase may be completed in about 1 ms.

In an embodiment, a method of preparing a composite material may include providing a thin film of a mixture including a chiral nematic liquid crystal and at least one polymerizable monomer, and polymerizing the at least one polymerizable monomer.

In some embodiments, the thin film may have, a thickness of about 0.1 μm to about 100 μm, about 0.25 μm to about 30 μm, about 10 μm to about 20 μm, or about 15 μm. Exemplary thin film thicknesses include, but are not limited to, about 0.25 μm, about 0.5 μm, about 0.75 μm, about 1 μm, about 1.5 μm, about 2 μm, about 4 μm, about 8 μm, about 10 μm, about 15 μm, about 20 μm, about 25 μ,, about 30 μm, about 50 μm, or any thickness or range of thicknesses between those listed, inclusive of endpoints.

In some embodiments, the mixture may be heated to a temperature that is high enough to solubilize the mixture, but low enough to prevent degradation. The temperature may vary based on the materials used. In some embodiments, the thin film may be prepared by heating the mixture to a temperature above a clearing point of the mixture and injecting the mixture into a cell. In these embodiments, the mixture may be heated before or after injecting the mixture into the cell. In some embodiments, the mixture may be heated to a temperature that is about 1° C. to about 20° C., about 2° C. to about 10° C. about 3° C. to about 7° C. higher than the clearing point of the mixture. Exemplary heating temperatures above the clearing point of the mixture include, but are not limited to, about 1° C., about 2° C., about 3° C. μm, about 5° C., about 7° C., about 10° C., about 15° C. μm, about 20° C., about 30° C., or any temperature or range of temperatures between those listed, inclusive of endpoints. In some embodiments, the mixture may be heated to about 40° C. to about 70° C.

In some embodiments, the mixture may be heated for a time period that is long enough to solubilize the mixture, but short enough to prevent degradation. In some embodiments, the mixture may be heated for at least about 5 minutes, at least about 10 minutes, at least about 15 minutes, at least about 20 minutes, at least about 25 minutes, at least about 30 minutes, at least about 35 minutes, at least about 40 minutes, at least about 45 minutes. In some embodiments, the mixture may be heated for about 5 minutes to about 45 minutes, about 10 minutes to about 35 minutes, about 15 minutes to about 30 minutes, or about 20 minutes to about 25 minutes. Exemplary heating times include, but are not limited to, about 5 minutes, about 10 minutes, about 15 minutes, about 20 minutes, about 25 minutes, about 30 minutes, about 35 minutes, about 40 minutes, about 45 minutes, or any time or range of times between those listed, inclusive of endpoints.

In some embodiments, the polymerizable monomer may be present in the mixture at about 2 weight percent to about 20 weight percent, at about 5 weight percent to about 10 weight percent, or at about 7 weight percent. Exemplary amounts of the polymerizable monomer include, but are not limited to, about 2%, about 4%, about 6%, about 8%, about 10%, about 12%, about 14%, about 16%, about 18%, about 20%, or any amount or range of amounts between those listed, inclusive of endpoints.

In some embodiments, the crosslinking monomer may be any crosslinking monomer known in the art wherein the crosslinking monomer is selected, based on its ability to form a suitable crosslinked polymer. In some embodiments, the crosslinking monomer may comprise at least one diacrylate monomer, diallyl monomer, or divinyl monomer. In some embodiments, the crosslinking monomer may comprise 1,4-bis-[4-(3-acryloyloxypropyloxy)benzoyloxy]-2-methylbenzene.

In some embodiments, the polymerizing operation may occur at a temperature where the mixture comprises a liquid crystal blue phase. In some embodiments, the polymerizing operation may occur at a temperature of about 24° C. to about 29° C.

In some embodiments, the thin film may further comprise at least one initiator. In some embodiments, the initiator may be any initiator known in the art which is a suitable for initiating selected monomers. In some embodiments, the thin film may further comprise a photosensitive initiator. In some embodiments, the photosensitive initiator may be any photosensitive initiator known in the art which is a suitable for initiating selected monomers. The photosensitive initiator may be selected based on available excitation sources, the constituents of the composite material, or a combination thereof. In some embodiments, the thin film may further comprise 2,2-dimethoxy-1,2-diphenylethan-1-one. In some embodiments, the polymerizing operation may comprise irradiating the mixture with electromagnetic radiation. In some embodiments, the electromagnetic radiation may include light at least one selected wavelength that activates the photosensitive initiator. In some embodiments, the electromagnetic radiation may comprise light at about 365 nm. In some embodiments, the electromagnetic radiation may have an intensity of about 2 mW/cm² to about 20 mW/cm², about 5 mW/cm² to about 15 mW/cm² or about 8.35 mW/cm². Exemplary intensities include, but are not limited to, 2 mW/cm², 5 mW/cm², 8 mW/cm², 12 mW/cm², 14 mW/cm², 16 mW/cm², 20 mW/cm², or any intensity or range of intensities between those listed, inclusive of endpoints. In some embodiments, the irradiating step may be performed for about 2 minutes to about 10 minutes, about 3 minutes about 8 minutes, or about 3 minutes. Exemplary irradiation times include, but are not limited to, 2 minutes, 3 minutes, 4 minutes, 5 minutes, 6 minutes, 7 minutes, 8 minutes, 9 minutes, 10 minutes, or any time or range of times between those listed, inclusive of endpoints.

In an embodiment, an optical device may comprise any of the composite materials described herein. In some embodiments, the composite material may comprise a chiral nematic liquid crystal and at least one crosslinked polymer that is the reaction product of at least one polymerizable monomer. In some embodiments, the at least one polymerizable monomer may comprise at least about 75% of a crosslinking monomer. In some embodiments, the composite material may have a liquid crystal blue phase with a stable temperature range of at least about 60° C. In some embodiments, the optical device may form at least a portion of a display device, an information storage device, a high speed photonic device used in optical communication, or a lens.

### EXAMPLES

### Example 1

### Fabrication of Polymer Stabilized Liquid Crystal Blue Phase

Chiral nematic liquid crystals (N*LCs) were prepared from a homemade nematic liquid crystal and the chiral dopant R811 (Merck, Germany) with the weight ratio of 3:1. A mixture containing N*LCs and photosensitive acrylate monomers RM257 (Sdyano Co. Ltd., Shijiachuang, China) with the weight ratio of 93:7 and about 0.5 wt % UV initiator Irgacure 651 was stirred for about 30 minutes at about 45° C. The mixture was then injected into a cell made of two indium tin oxide-coated (ITO) glass plates separated by a 15 μm-thick transparent Mylar® spacer. The cell was settled on a precisely controlled hot stage (Linkam LT120S, UK) and exposed to 365 nm UV light at about 29° C. for 3 minutes or more. The intensity of the UV source was modulated to 8.35 mW/cm².

The blue phase range of the sample was tested before and after polymerization by exposure to the UV source. Before polymerization the blue phase range was from 28.5 to 24.3° C. and after polymerization the range was from 34.2° C. to a temperature lower than −32° C. (the lower limit of the instrument). These results indicate that the crosslinked polymer is adding significant stability to the liquid crystal blue phase. Applications using a liquid crystal blue phase may benefit greatly from this increased stability.

### Example 2

### Electrically Induced Phase Transitions

The cell containing the liquid crystal blue phase from Example 1 was positioned on a microscope with a cross polarizer, and a 1 kHz-square wave was applied across the two electrodes. As the voltage was increased there was no evident change in the texture of the sample, until the voltage exceeded the threshold value of 0.4 V per μm of thickness. As the voltage continually increased, at first, some bright and small balls appeared, and then coalesced together, and finally formed the chiral nematic phase at about 2 V per μm of thickness. The chiral nematic phase was stable from about 2 V per μm of thickness to about 4.2 V per μm of thickness. Due to homeotropic alignment of liquid crystals, the whole field changed to dark state if the voltage reached the saturation value of about 5.3 V per μm of thickness. When the voltage was removed slowly from the saturation value, the homeotropic state transitioned to the chiral nematic again and the chiral nematic phase persisted even after the voltage was totally removed. In contrast, when the applied voltage was removed rapidly from the saturation, the blue phase reappeared. Similarly, the blue phase directly transitioned to the dark state when the voltage was increased instantaneously to the saturation. The rapid decreasing or increasing of voltage appeared to prevent the liquid crystals from forming the chiral nematic phase. As a result, the sample transitioned over the chiral nematic.

It was evident that the transitions from the chiral nematic to the homeotropic state and the blue phase to the homeotropic state were reversible, but it was not for the blue phase to the chiral nematic. The initial blue phase could transit to chiral nematic, and then to homeotropic state as the voltage was slowly increased; wherein the chiral nematic existed at the voltages between about 2 and about 4.2 V/μm. The homeotropic state transitioned to the chiral nematic when the voltage was decreased slowly, but the blue phase did not appear at the end. However, the blue phase and homeotropic state did transit back and forth when the voltage was applied and removed rapidly. The response time showed that the rise and fall times of the transition between blue phase and homeotropic state were 0.5 ms and 1 ms, respectively. The contrast ratio between the phases based on transmission at each state was 170 and 30 for the transition between blue phase and homeotropic state and the transition between chiral nematic and homeotropic state, respectively.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or figure, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 substituents refers to groups having 1, 2, or 3 substituents. Similarly, a group having 1-5 substituents refers to groups having 1, 2, 3, 4, or 5 substituents, and so forth.

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

1. A composite material comprising:
a chiral nematic liquid crystal; and
a crosslinked polymer that is the reaction product of at least one polymerizable monomer comprising at least about 75% of a crosslinking monomer.

2. The composite material of claim 1, wherein the chiral nematic liquid crystal comprises about 60 weight percent to about 90 weight percent nematic liquid crystals and about 10 weight percent to about 40 weight percent chiral dopant.

3-4. (canceled)

5. The composite material of claim 1, wherein the crosslinked polymer is present in the composite material at about 2 weight percent to about 20 weight percent.

6-7. (canceled)

8. The composite material of claim 1, wherein the composite material has a thickness of about 0.25 μm to about 30 μm.

9-12. (canceled)

13. The composite material of claim 1, wherein the crosslinked polymer is a polyacrylate polymer and the crosslinking monomer comprises a diacrylate monomer.

14. (canceled)

15. The composite material of claim 1, wherein the composite material has a liquid crystal blue phase.

16. The composite material of claim 1, wherein the composite material is a bistable liquid crystal.

17. The composite material of claim 16, wherein the composite material has a liquid crystal blue phase and chiral nematic phase.

18. The composite material of claim 15, wherein the liquid crystal blue phase of the composite material has a stable temperature range of about 20° C. to about 100° C.

19-23. (canceled)

24. The composite material of claim 1, wherein the composite material is configured to transition from a liquid crystal blue phase to a chiral nematic phase when the composite material is in an electric field with a strength that is increased above a threshold value and below a saturation value.

25. (canceled)

26. The composite material of claim 1, wherein the composite material is configured to transition from a chiral nematic phase to a homeotropic phase when the composite material is in an electric field with a strength that is increased to above a saturation value.

27. (canceled)

28. The composite material of claim 1, wherein the composite material has a stable chiral nematic phase when the composite material is in an electric field with a strength that is above a threshold value and below a saturation value.

29-32. (canceled)

33. The composite material of claim 1, wherein the composite material is configured to transition from a homeotropic phase to a chiral nematic phase when the composite material is in an electric field with a strength that is below a saturation value and above a threshold value.

34-37. (canceled)

38. A method of preparing a composite material, the method comprising:
providing a thin film comprising a mixture of a chiral nematic liquid crystal and at least one polymerizable monomer, wherein the at least one polymerizable monomer comprises at least about 75% of a crosslinking monomer; and
polymerizing the at least one polymerizable monomer, whereby the composite material is prepared.

39. (canceled)

40. The method of claim 38, wherein the thin film further comprises a photosensitive initiator.

41. (canceled)

42. The method of claim 38, wherein the chiral nematic liquid crystal comprises about 60 weight percent to about 90 weight percent nematic liquid crystals and about 10 weight percent to about 40 weight percent chiral dopant.

43-44. (canceled)

45. The method of claim 38, wherein the polymerizable monomer is present in the mixture at about 2 weight percent to about 20 weight percent.

46-47. (canceled)

48. The method of claim 38, wherein the thin film has a thickness of about 0.25 μm to about 30 μm.

49-52. (canceled)

53. The method of claim 38, wherein the crosslinking monomer comprises at least one diacrylate monomer.

54. (canceled)

55. The method of claim 38, wherein the providing step comprises:
heating the mixture to a temperature above a clearing point of the mixture; and
injecting the mixture into a cell, whereby the thin film is prepared and wherein the heating step occurs before or after the injecting step.

56. The method of claim 55, wherein the mixture is heated to a temperature about 2° C. to about 10° C. higher than the clearing point of the mixture.

57-59. (canceled)

60. The method of claim 38, wherein the polymerizing step occurs at a temperature where the mixture comprises a liquid crystal blue phase.

61-62. (canceled)

63. The method of claim 40, wherein the polymerizing step comprises irradiating the mixture with electromagnetic radiation comprising light at least one selected wavelength, wherein the selected wavelength activates the photosensitive initiator.

64-68. (canceled)

69. An optical device comprising a composite material, wherein the composite material comprises:
a chiral nematic liquid crystal; and at least one crosslinked polymer that is the reaction product of at least one polymerizable monomer comprising at least about 75% of a crosslinking monomer, wherein the composite material has a liquid crystal blue phase with a stable temperature range of at least about 60° C.

70. The optical device of claim 69, wherein the optical device form at least a portion of a display device, an information storage device, a high speed photonic device used in optical communication, or a lens.
